(19) United States
(12) Patent Application Publication
(10) Pub. No.: US 2026/0296026 A1
(43) Pub. Date: Oct. 1, 2026

(54) Washing Device

(71) Applicant: SEIKO EPSON CORPORATION, Tokyo (JP)

(72) Inventor: Mio SASAKI, Shiojiri (JP)

(21) Appl. No.: 19/577,491

(22) Filed: Mar. 25, 2026

(30) Foreign Application Priority Data
Mar. 26, 2025 (JP) 2025-050874

(51) Int. Cl. B41J 2/165

(52) U.S. Cl. CPC B41J 2/16517; B41J 2002/16567

(57) ABSTRACT

A washing device includes a liquid ejection head and a washing unit disposed below the liquid ejection head, wherein the liquid ejection head includes a pressure chamber that applies pressure to liquid stored therein, and a nozzle plate in which at least one nozzle is formed that communicates with the pressure chamber, the nozzle plate has an ejection surface in which a nozzle opening is formed, and the washing unit includes a cap that is disposed to face the ejection surface and that covers the ejection surface, an ultrasonic device disposed on an inner surface of the cap that faces the ejection surface, and a vibrator that is disposed below the nozzle opening, that has a lower end fixed to an upper surface of the ultrasonic device, that propagates ultrasonic waves transmitted from the ultrasonic device, and that transmits the ultrasonic waves from an upper end thereof.

The present application is based on, and claims priority from JP Application Serial Number 2025-050874, filed Mar. 26, 2025, the disclosure of which is hereby incorporated by reference herein in its entirety.

### BACKGROUND

### 1. Technical Field

The present disclosure relates to a washing device.

### 2. Related Art

JP-A-2006-347000 discloses a liquid droplet ejection device in which an ultrasonic transducer is attached to a cap mounted on an ejection head in order to prevent evaporation of an ejection liquid. In this device, the ejection nozzle is covered with a cap in a state where the inside of the ejection nozzle and the inside of the cap are filled with a liquid, and ultrasonic waves are oscillated from the ultrasonic transducer to clean the ejection nozzle and the nozzle plate.

In the configuration described in JP-A-2006-347000, the distance over which the ultrasonic waves transmitted from the ultrasonic device propagate through the liquid before reaching the nozzle is relatively long. As a result, the ultrasonic waves may attenuate during propagation, which could lead to a reduction in the performance of removing foreign matter adhering to the nozzle.

### SUMMARY

According to a first aspect of the present disclosure, a washing device is provided. The washing device includes a liquid ejection head and a washing unit disposed below the liquid ejection head, wherein the liquid ejection head includes a piezoelectric element, a diaphragm that vibrates by drive of the piezoelectric element, a pressure chamber that applies pressure to liquid stored therein by vibration of the diaphragm, and a nozzle plate in which are formed a plurality of nozzles that communicate with the pressure chamber and that eject the liquid, the nozzle plate has, on a lower surface of the nozzle plate, an ejection surface in which is formed a nozzle opening of a nozzle, and the washing unit includes a cap that is disposed to face the ejection surface and that covers the ejection surface, an ultrasonic device disposed on an inner surface of the cap that faces the ejection surface, and a vibrator that is disposed below the nozzle opening, that has a lower end fixed to an upper surface of the ultrasonic device, that propagates ultrasonic waves transmitted from the ultrasonic device, and that transmits the ultrasonic waves from an upper end thereof.

### BRIEF DESCRIPTION OF THE DRAWINGS

FIG. 1 is an explanatory diagram illustrating a schematic configuration of a liquid ejection device.

FIG. 2 is an exploded perspective view illustrating a configuration of the liquid ejection head.

FIG. 3 is an explanatory view illustrating a configuration of the liquid ejection head in plan view.

FIG. 4 is a cross-sectional view taken along line IV-IV in FIG. 3.

FIG. 5 is a cross-sectional view schematically illustrating a detailed configuration of the piezoelectric element.

FIG. 6 is an explanatory view illustrating a schematic configuration of a washing unit.

FIG. 7 is a top view of the cap.

FIG. 8 is a schematic diagram illustrating a state in which a cap is mounted on the liquid ejection head.

FIG. 9 is a plan view illustrating a schematic configuration of the ultrasonic device.

FIG. 10 is a cross-sectional view taken along line X-X in FIG. 9.

FIG. 11 is a cross-sectional view taken along line XI-XI in FIG. 9.

FIG. 12 is a flowchart illustrating a nozzle washing method.

FIG. 13 is an explanatory view illustrating a schematic configuration of a vibrator in a second embodiment.

FIG. 14 is an explanatory view illustrating a schematic configuration of a vibrator in a third embodiment.

### DESCRIPTION OF EMBODIMENTS

### A. FIRST EMBODIMENT

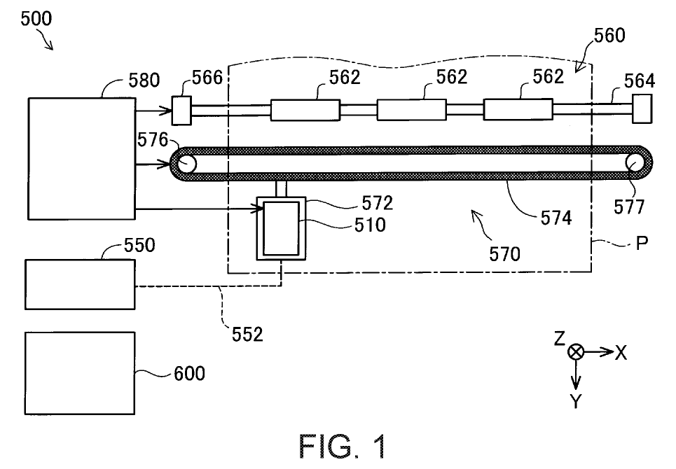

FIG. 1 is an explanatory diagram illustrating a schematic configuration of a liquid ejection device 500. In the present embodiment, the liquid ejection device 500 is an inkjet printer that forms an image by ejecting ink, which is an example of a liquid, onto a printing paper sheet P. The liquid ejection device 500 may eject ink onto any type of medium such as a resin film or a fabric instead of the printing paper sheet P. In FIG. 1, arrows indicating X, Y, and Z directions orthogonal to each other are illustrated. The X direction and the Y direction are directions parallel to a horizontal plane. The Z direction is a direction parallel to the vertical direction. The X, Y, and Z directions in FIG. 1 and the X, Y, and Z directions in other drawings indicate the same directions. When specifying the direction, the positive direction indicated by an arrow is designated as “+”, the negative direction opposite to the direction indicated by the arrow is designated as “-”, and the positive and negative signs are used together for direction notation. In the present specification, the +Z direction indicates a vertically downward direction, and the -Z direction indicates a vertically upward direction.

The liquid ejection device 500 includes a liquid ejection head 510, an ink tank 550, a transport mechanism 560, a movement mechanism 570, a washing unit 600, and a control section 580. A plurality of nozzles is formed in the liquid ejection head 510, and, for example, ink of a total of four colors of black, cyan, magenta, and yellow is ejected in the +Z direction to form an image on the printing sheet P. The liquid ejection head 510 is mounted on a carriage 572 and reciprocates in the main scanning direction along with the movement of the carriage 572. In the present embodiment, the main scanning direction is the +X direction and the -X direction.

The ink tank 550 stores ink to be ejected by the liquid ejection head 510. The ink tank 550 is connected to the liquid ejection head 510 by a tube 552 made of resin. The ink in the ink tank 550 is supplied to the liquid ejection head 510 via the tube 552. Note that a bag-shaped liquid pack formed of a flexible film may be provided instead of the ink tank 550.

The transport mechanism 560 transports the printing sheet P in the sub-scanning direction. The sub-scanning direction is a direction intersecting the X direction, which is the main scanning direction, and is the +Y direction and the -Y direction in the present embodiment. The transport mechanism 560 includes a transport rod 564 to which three transport rollers 562 are attached, and a transport motor 566 that rotationally drives the transport rod 564. The transport motor 566 rotationally drives the transport rod 564 and, by this, the printing sheet P is transported in the +Y direction, which is the sub-scanning direction. The number of transport rollers 562 is not limited to three, and may be any number.

The movement mechanism 570 includes the carriage 572, a transport belt 574, a drive motor 576, and a pulley 577. The carriage 572 is equipped with the liquid ejection head 510 in a state of being capable of ejecting ink. The carriage 572 is fixed to the transport belt 574. The transport belt 574 is stretched between the drive motor 576 and the pulley 577. The drive motor 576 is rotationally driven to reciprocate the transport belt 574 in the main scanning direction. By this, the carriage 572 fixed to the transport belt 574 also reciprocates in the main scanning direction.

The washing unit 600 cleans the nozzles of the liquid ejection head 510. The washing unit 600 will be described in detail later. In the present disclosure, the washing unit 600 and the liquid ejection head 510 are collectively referred to as a washing device.

The control section 580 is configured as a microcomputer including a CPU and a storage section. The storage section is, for example, a nonvolatile memory that can be erased by an electric signal such as an EEPROM, a nonvolatile memory that can be erased by ultraviolet rays such as a one time-PROM or an EPROM, or a nonvolatile memory that cannot be erased such as a PROM. The storage section stores various programs for implementing functions provided in the present embodiment. The CPU deploys and executes a program stored in the storage section, thereby controlling each unit of the liquid ejection device 500. The control section 580 controls a reciprocating operation of the carriage 572 along the main scanning direction, a transport operation of the printing sheet P along the sub-scanning direction, an ejecting operation of ejecting liquid from the liquid ejection head 510, and the like.

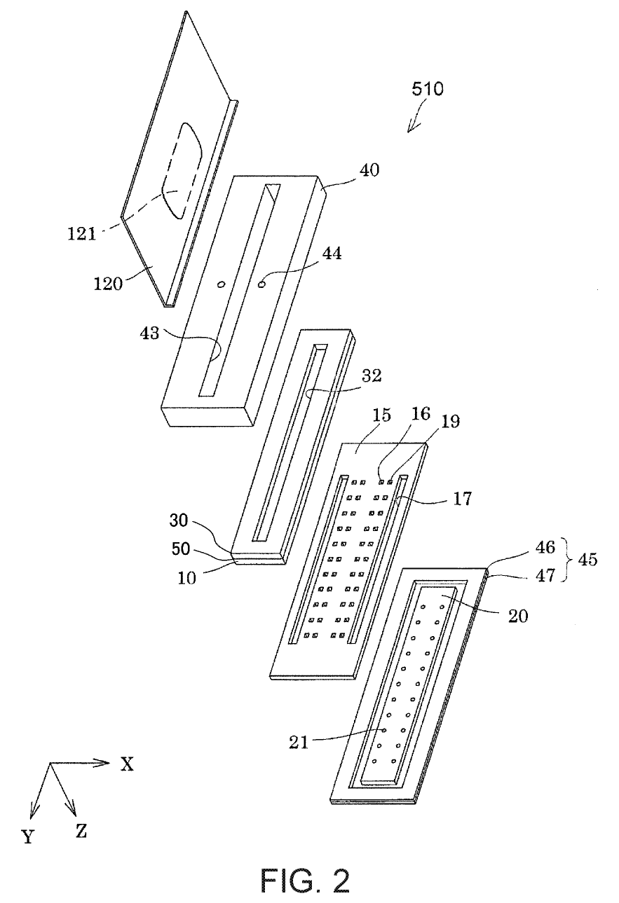

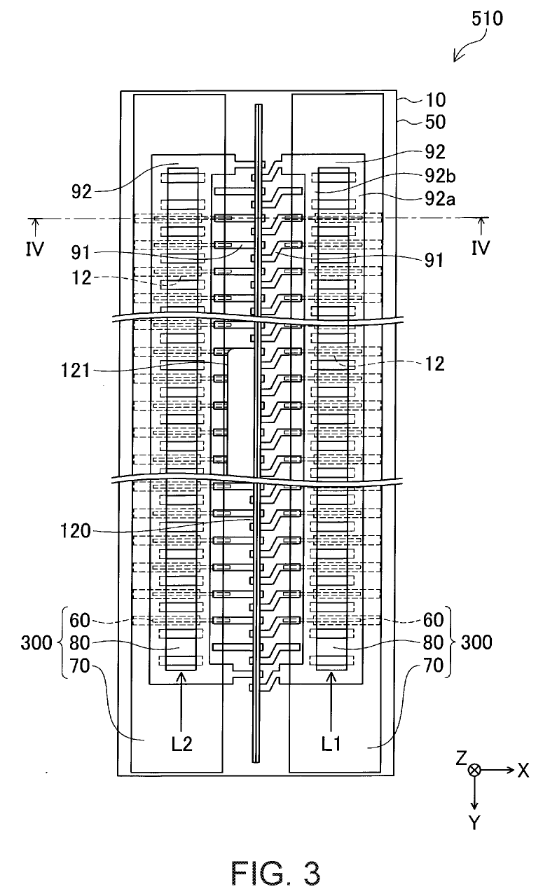

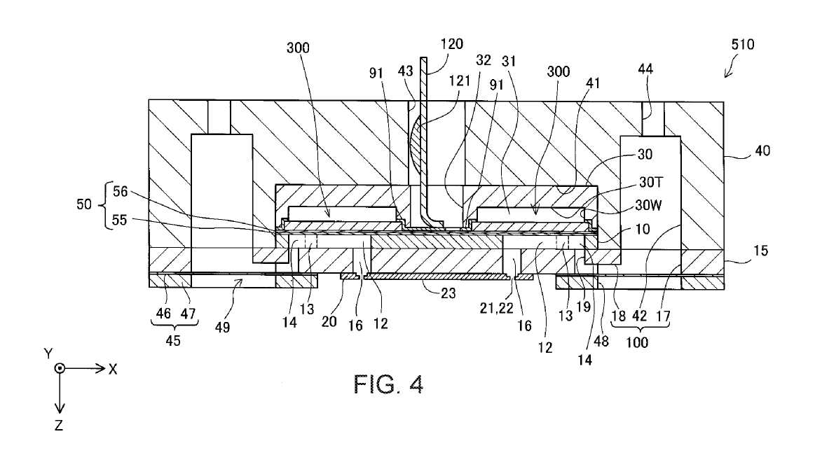

A detailed configuration of the liquid ejection head 510 will be described with reference to FIGS. 2 to 4. FIG. 2 is an exploded perspective view illustrating a configuration of the liquid ejection head 510. FIG. 3 is an explanatory view illustrating a configuration of the liquid ejection head 510 in plan view. In the present disclosure, "plan view" means a state in which an object is viewed along the vertical direction. FIG. 3 illustrates a configuration of the periphery of a pressure chamber substrate 10 and a diaphragm 50 in the liquid ejection head 510, and illustration of a protection film 82, a sealing substrate 30, a case member 40, and the like is omitted in order to facilitate understanding of the technology. FIG. 4 is a cross-sectional view taken along line IV-IV in FIG. 3.

The liquid ejection head 510 includes the pressure chamber substrate 10 illustrated in FIG. 2, a communication plate 15, a nozzle plate 20, a compliance substrate 45, the diaphragm 50, the sealing substrate 30, the case member 40, a wiring substrate 120, and a piezoelectric element 300 illustrated in FIG. 3. The liquid ejection head 510 is formed by stacking these stacked members. In the present disclosure, a direction in which the stacked members forming the liquid ejection head 510 are stacked is also referred to as a "stacking direction." In the present embodiment, the stacking direction coincides with the Z direction.

The pressure chamber substrate 10 is formed using, for example, a silicon substrate, a glass substrate, an SOI substrate, various ceramic substrates, or the like. As illustrated in FIG. 3, a plurality of pressure chambers 12 is formed in the pressure chamber substrate 10. The pressure chamber 12 is provided to extend along the X direction. Specifically, the pressure chamber 12 is formed in a substantially rectangular shape in which the length in the X direction is longer than the length in the Y direction in plan view. The shape of the pressure chamber 12 is not limited to a rectangular shape, and may be a parallelogram shape, a polygonal shape, or the like. In the present specification, the X direction is also referred to as an "extension direction."

As illustrated in FIG. 3, the plural pressure chambers 12 are arranged in the pressure chamber substrate 10 along a direction intersecting the extension direction. In the present specification, the direction in which the plural pressure chambers 12 are arranged in plan view is also referred to as an "arrangement direction." In the present embodiment, the plural pressure chambers 12 are arranged in two rows parallel to each other with the Y direction as the arrangement direction. In the example of FIG. 3, two pressure chamber rows are formed in the pressure chamber substrate 10, that is, a first pressure chamber row L1 having a first arrangement direction parallel to the Y direction and a second pressure chamber row L2 having a second arrangement direction parallel to the Y direction.

As illustrated in FIG. 2, the communication plate 15, the nozzle plate 20, and the compliance substrate 45 are stacked on the +Z direction side of the pressure chamber substrate 10. The communication plate 15 is a flat plate-shaped member using, for example, a silicon substrate, a glass substrate, an SOI substrate, various ceramic substrates, a metal substrate, or the like. The communication plate 15 is provided with a nozzle communication path 16, a first manifold section 17, a second manifold section 18 illustrated in FIG. 4, and a supply communication path 19.

As illustrated in FIG. 4, the nozzle communication path 16 is a flow path that communicates the pressure chamber 12 and a nozzle 21. The first manifold section 17 and the second manifold section 18 function as a part of a manifold 100 that is a common liquid chamber with which the plurality of pressure chambers 12 communicate. The first manifold section 17 is provided so as to penetrate the communication plate 15 in the Z direction. As illustrated in FIG. 4, the second manifold section 18 is provided on the surface of the communication plate 15 on the +Z direction side without penetrating the communication plate 15 in the Z direction.

As illustrated in FIG. 4, the supply communication path 19 is a flow path connected to a pressure chamber supply path 14 provided in the pressure chamber substrate 10. The pressure chamber supply path 14 is a flow path connected to one end section of the pressure chamber 12 in the X direction via a narrow section 13. The narrow section 13 is a flow path provided between the pressure chamber 12 and the pressure chamber supply path 14. The narrow section 13 is a flow path whose inner wall protrudes more than the pressure chamber 12 and the pressure chamber supply path 14 and that is formed to be narrower than the pressure chamber 12 and the pressure chamber supply path 14. By this, the narrow section 13 has a higher flow path resistance than the pressure chamber 12 and the pressure chamber supply path 14. With this configuration, even when pressure is applied to the pressure chamber 12 by the piezoelectric element 300 at the time of ejecting ink, it is possible to suppress or prevent the ink in the pressure chamber 12 from flowing back to the pressure chamber supply path 14. The supply communication paths 19 are provided in a plurality and are arranged in the Y direction, that is, in the arrangement direction, and each is individually associated with the respective pressure chamber 12. The supply communication path 19 and the pressure chamber supply path 14 communicate the second manifold section 18 with each pressure chamber 12, and supply the ink in the manifold 100 to each pressure chamber 12.

The nozzle plate 20 is provided on the opposite side of the pressure chamber substrate 10 with the communication plate 15 interposed therebetween, that is, on the surface of the communication plate 15 on the +Z direction side. The material of the nozzle plate 20 is not particularly limited, and for example, a silicon substrate, a glass substrate, an SOI substrate, various ceramic substrates, and a metal substrate can be used. Examples of the metal substrate include a stainless steel substrate. As the material of the nozzle plate 20, organic material such as a polyimide resin may be used.

The nozzle plate 20 has a plurality of nozzles 21 formed therein. Each nozzle 21 communicates with each pressure chamber 12 via the nozzle communication paths 16. As illustrated in FIG. 2, the plural nozzles 21 are arranged along the arrangement direction of the pressure chambers 12, that is, the Y direction. The nozzle plate 20 is provided with two nozzle rows in which the plural nozzles 21 are arranged in a row. The two nozzle rows correspond to the first pressure chamber row L1 and the second pressure chamber row L2, respectively. As illustrated in FIG. 4, the nozzle plate 20 has an ejection surface 23 on which a nozzle opening 22 of the nozzle 21 is formed. The ejection surface 23 is a lower surface of the nozzle plate 20, that is, a surface of the nozzle plate 20 on the +Z direction side.

As illustrated in FIG. 4, the compliance substrate 45 is provided on the opposite side to the pressure chamber substrate 10 with the communication plate 15 interposed therebetween, that is, on the surface of the communication plate 15 on the +Z direction side, together with the nozzle plate 20. The compliance substrate 45 is provided around the nozzle plate 20 and covers the openings of the first manifold section 17 and the second manifold section 18 mounted on the communication plate 15. The compliance substrate 45 includes, for example, a sealing film 46 formed of a flexible thin film and a mounting substrate 47 formed of a hard material such as metal. As illustrated in FIG. 4, a region of the mounting substrate 47 facing the manifold 100 is completely removed in the thickness direction to define an opening section 48. Therefore, one surface of the manifold 100 is a compliance section 49 sealed only by the sealing film 46.

As illustrated in FIG. 4, the diaphragm 50 and the piezoelectric element 300 are stacked on the opposite side of the pressure chamber substrate 10 from the communication plate 15 and the like, that is, on the surface of the pressure chamber substrate 10 on the -Z direction side. The piezoelectric element 300 causes the diaphragm 50 to be bent and deformed, and causes a pressure change in the ink in the pressure chamber 12. In FIG. 4, the piezoelectric element 300 is illustrated in a simplified manner.

The diaphragm 50 is provided between the piezoelectric element 300 and the pressure chamber substrate 10. The diaphragm 50 is provided at a position closer to the pressure chamber substrate 10 than the piezoelectric element 300 and includes an elastic film 55 having silicon oxide (SiO2) and an insulating film 56 provided on the elastic film 55 and having a zirconium oxide film (ZrO2). The elastic film 55 constitutes a surface on the -Z direction side of the flow path such as the pressure chamber 12. The diaphragm 50 may be formed of, for example, either the elastic film 55 or the insulating film 56, or may include a film other than the elastic film 55 and the insulating film 56. Examples of the material of the other film include silicon, silicon nitride and the like.

As illustrated in FIG. 2, the sealing substrate 30 having substantially the same size as the pressure chamber substrate 10 in plan view is further bonded to the surface of the pressure chamber substrate 10 on the -Z direction side by an adhesive or the like. As illustrated in FIG. 4, the sealing substrate 30 includes a ceiling section 30T, a side wall section 30W, a holding section 31, and a through hole 32. The holding section 31 is a space partitioned by the ceiling section 30T and the side wall section 30W, and protects the active section of the piezoelectric element 300 by housing the piezoelectric element 300. In the present embodiment, the holding section 31 is provided for each row of the piezoelectric elements 300 and, more specifically, two holding sections 31 corresponding to the first pressure chamber row L1 and the second pressure chamber row L2 are formed adjacent to each other. The through hole 32 penetrates the sealing substrate 30 along the Z direction. The through hole 32 is disposed between the two holding sections 31 in plan view, and is formed in a rectangular shape elongated along the Y direction.

As illustrated in FIG. 4, the case member 40 is fixed on the sealing substrate 30. Together with the communication plate 15, the case member 40 forms the manifold 100 communicating with the plurality of pressure chambers 12. The case member 40 has substantially the same outer shape as the communication plate 15 in plan view, and is bonded so as to cover the sealing substrate 30 and the communication plate 15.

The case member 40 includes a housing section 41, a supply port 44, a third manifold section 42, and a connecting port 43. The housing section 41 is a space having a depth capable of accommodating the pressure chamber substrate 10, the diaphragm 50, and the sealing substrate 30. The third manifold section 42 is a space formed in the vicinity of both ends of the housing section 41 in the X direction in the case member 40. The manifold 100 is formed by connecting the third manifold section 42 to the first manifold section 17 and the second manifold section 18 provided in the communication plate 15. The manifold 100 has a shape elongated in the Y direction. The supply port 44 is communicating with the manifolds 100 to supply ink to each manifold 100. The connecting port 43 is a through hole communicating with the through hole 32 of the sealing substrate 30, and the wiring substrate 120 is inserted therethrough.

The liquid ejection head 510 takes in the ink supplied from the ink tank 550 illustrated in FIG. 1 via the supply port 44 illustrated in FIG. 4, fills an internal flow path from the manifold 100 to the nozzle 21 with the ink, and then applies a voltage based on a drive signal to each of the piezoelectric elements 300 that correspond to the plural pressure chambers 12. Accordingly, the diaphragm 50 bends and deforms together with the piezoelectric element 300, causing the volume of each pressure chamber 12 to change, increasing the internal pressure, and ejecting ink droplets from each nozzle 21.

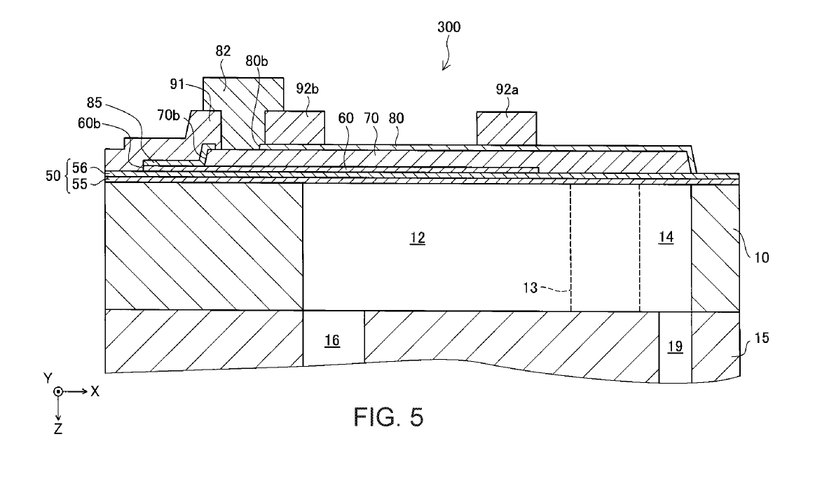

The configuration of the piezoelectric element 300 will be described with reference to FIG. 5 as appropriate together with FIGS. 3 and 4. FIG. 5 is a cross-sectional view schematically illustrating a detailed configuration of the piezoelectric element 300. As illustrated in FIG. 5, the piezoelectric element 300 includes a first electrode 60, a piezoelectric body 70, and a second electrode 80. The first electrode 60, the piezoelectric body 70, and the second electrode 80 are stacked in this order in the -Z direction of the stacking direction. The piezoelectric body 70 is provided between the first electrode 60 and the second electrode 80 in the stacking direction.

The first electrode 60 and the second electrode 80 are electrically coupled with the wiring substrate 120 illustrated in FIGS. 3 and 4 via the drive wiring. The drive wiring includes a first drive wiring 91 that electrically couples the wiring substrate 120 and the first electrode 60, and a second drive wiring 92 that electrically couples the wiring substrate 120 and the second electrode 80. The first electrode 60 and the second electrode 80 apply a voltage corresponding to the drive signal to the piezoelectric body 70. The drive voltage is a voltage applied to the piezoelectric element 300 from the first electrode 60 and the second electrode 80 by the control section 580 in order to drive the piezoelectric element 300. In the piezoelectric element 300, a portion where piezoelectric strain occurs in the piezoelectric body 70 when a voltage is applied between the first electrode 60 and the second electrode 80 is referred to as an active section, and a portion where piezoelectric strain does not occur in the piezoelectric body 70 is referred to as a non-active section.

A different drive voltage is applied to the first electrode 60 according to the ink ejection amount, and a predetermined reference voltage is applied to the second electrode 80 regardless of the ink ejection amount. When a voltage difference is generated between the first electrode 60 and the second electrode 80 by the application of the drive voltage and the reference voltage, the piezoelectric body 70 of the piezoelectric element 300 is deformed. The deformation of the piezoelectric body 70 causes the diaphragm 50 to deform or vibrate, which changes the volume of the pressure chamber 12. The change in the volume of the pressure chamber 12 applies pressure to the ink contained in the pressure chamber 12, and the ink is ejected from the nozzle 21 via the nozzle communication path 16.

The first electrode 60 is an individual electrode provided individually for each of the plurality of pressure chambers 12. As illustrated in FIG. 5, the first electrode 60 is a lower electrode provided on the opposite side of the piezoelectric body 70 from the second electrode 80, that is, on the underside of the piezoelectric body 70. The first electrode 60 is formed of a conductive material such as a metal such as platinum (Pt), iridium (Ir), gold (Au), or titanium (Ti), or a conductive metal oxide such as indium tin oxide abbreviated as ITO. The first electrode 60 may be formed by stacking a plurality of materials such as platinum (Pt), iridium (Ir), gold (Au), titanium (Ti) and the like.

As illustrated in FIG. 3, the piezoelectric body 70 has a predetermined width in the X direction and is elongated in a rectangular shape along the arrangement direction of the pressure chambers 12, that is, along the Y direction. The piezoelectric body 70 may be a crystal film having a perovskite structure that is formed on the first electrode 60 and that is made of ferroelectric ceramic material exhibiting an electromechanical conversion action, that is, a so-called perovskite crystal. As the material of the piezoelectric body 70, for example, a ferroelectric piezoelectric material such as lead zirconate titanate (PZT), material obtained by adding a metal oxide such as niobium oxide, nickel oxide, or magnesium oxide to the ferroelectric piezoelectric material, or the like can be used. Specific examples of the material include lead titanate (PbTiO₃), lead zirconate titanate (Pb(Zr,Ti)O₃), lead zirconate (PbZrO₃), lanthanum lead titanate ((Pb,La),TiO₃), lanthanum lead zirconate titanate ((Pb,La)(Zr,Ti)O₃), and magnesium niobate lead zirconate titanate (Pb(Zr,Ti)(Mg,Nb)O₃).

The material of the piezoelectric body 70 is not limited to a lead-based piezoelectric material containing lead, and a lead-free piezoelectric material not containing lead can also be used. Examples of the lead-free piezoelectric material include bismuth ferrate ((BiFeO₃), abbreviated as "BFO”), barium titanate ((BaTiO₃), abbreviated as "BT”), potassium sodium lithium niobate ((K,Na,Li)(NbO₃)), potassium sodium lithium tantalate niobate ((K,Na,Li)(Nb,Ta)O₃), bismuth potassium titanate ((Bi_{1/2}K_{1/2})TiO₃, abbreviated as "BKT”), bismuth sodium titanate ((Bi_{1/2}Na_{1/2})TiO₃, abbreviated as "BNT”), bismuth manganate ((BiMnO₃), abbreviated as "BM”), composite oxides containing bismuth, potassium, titanium, and iron and having a perovskite structure (x[(BiₓK₁₋ₓ)TiO₃]-(1-x) [BiFeO₃], abbreviated as "BKT-BF”), composite oxides containing bismuth, iron, barium, and titanium and having a perovskite structure ((1−x)[BiFeO₃]−x[BaTiO₃], abbreviated as "BFO-BT”), composite oxides obtained by further adding metals such as manganese, cobalt, or chromium to the aforementioned material ((1−x)[Bi(Fe_{1-y}M_{y})O₃]−x[BaTiO₃] (where M is Mn, Co, or Cr)), and the like.

As illustrated in FIG. 3, the second electrode 80 is a common electrode provided common to the plurality of pressure chambers 12. The second electrode 80 has a predetermined width in the X direction and is provided to extend along the arrangement direction of the pressure chambers 12, that is, the Y direction. As illustrated in FIG. 5, the second electrode 80 is an upper electrode provided on the opposite side of the piezoelectric body 70 from the first electrode 60, that is, on the upper side of the piezoelectric body 70. The second electrode 80 is formed of a conductive material such as a metal such as platinum (Pt), iridium (Ir), gold (Au), or titanium (Ti), or a conductive metal oxide such as indium tin oxide abbreviated as ITO. The second electrode 80 may be formed by stacking a plurality of materials such as platinum (Pt), iridium (Ir), gold (Au), titanium (Ti) and the like.

As illustrated in FIG. 5, the protection film 82 is formed on an end section of the second electrode 80 on the -X direction side. A material having electrical insulation properties and moisture barrier properties is used as the material of the protection film 82. For example, an oxide insulating film such as aluminum oxide or hafnium oxide, a polymer material film such as polyimide, or the like can be adopted as the protection film 82. The protection film 82 is formed so as to cover one end section 80b of the second electrode 80 and the surface of the piezoelectric body 70.

As illustrated in FIG. 5, a wiring section 85 is provided on the -X direction side of the end section of the second electrode 80, further toward the -X direction. In FIG. 3, the wiring section 85 is not illustrated. The wiring section 85 is in the same layer as the second electrode 80, but is electrically discontinuous with the second electrode 80. The wiring section 85 is formed in a state spaced apart from the one end section 80b of the second electrode 80, extending from one end section 70b of the piezoelectric body 70 in the -X direction to one end section 60b of the first electrode 60 in the -X direction. The one end section 60b of the first electrode 60 in the -X direction is drawn out to the outside of the one end section 70b of the piezoelectric body 70. A wiring section 85 is provided for each piezoelectric element 300, and the plural wiring sections 85 are arranged at predetermined intervals along the Y direction. The wiring section 85 may be formed in a layer different from the second electrode 80.

As illustrated in FIG. 5, the first drive wiring 91 is electrically coupled to the first electrode 60, which is the individual electrode, and an extended section 92a and an extended section 92b of the second drive wiring 92 is electrically coupled to the second electrode 80, which is the common electrode. The first drive wiring 91 and the second drive wiring 92 function as drive wirings for applying a voltage from the wiring substrate 120 to drive the piezoelectric body 70.

The first drive wiring 91 is provided individually for each first electrode 60. As illustrated in FIG. 5, the first drive wiring 91 is coupled to the vicinity of the one end section 60b of the first electrode 60 via the wiring section 85, and is drawn out in the -X direction until reaching the diaphragm 50. The first drive wiring 91 is electrically coupled to the one end section 60b in the -X direction of the first electrode 60 that is drawn out to the outside of the one end section 70b of the piezoelectric body 70. The wiring section 85 may be omitted, and the first drive wiring 91 may be directly connected to the one end section 60b of the first electrode 60.

As illustrated in FIG. 3, the second drive wiring 92 extends along the Y direction, is bent at both Y direction ends, and is drawn out along the X direction. The second drive wiring 92 has the extended section 92a and the extended section 92b extending along the Y direction. As illustrated in FIGS. 3 and 4, the end sections of the first drive wiring 91 and the second drive wiring 92 are extended so as to be exposed in the through hole 32 of the sealing substrate 30, and are electrically connected to the wiring substrate 120 in the through hole 32.

The first drive wiring 91 and the second drive wiring 92 are formed in the same layer in a state of being electrically discontinuous to each other. The first drive wiring 91 and the second drive wiring 92 may be formed in different layers. The material of the first drive wiring 91 and the second drive wiring 92 are made of a material having conductivity, and for example, gold (Au), copper (Cu), titanium (Ti), tungsten (W), nickel (Ni), chromium (Cr), platinum (Pt), aluminum (Al), or the like can be used.

The wiring substrate 120 is formed of, for example, a flexible printed circuit (FPC). The wiring substrate 120 has a plurality of wirings formed thereon for connection with the control section 580 and a power supply circuit (not illustrated). Note that the FPC may be replaced with a flexible substrate, for example, a flexible flat cable (FFC). An integrated circuit 121 including a switching element and the like is mounted on the wiring substrate 120. A command signal for driving the piezoelectric element 300 and the like are input to the integrated circuit 121. The integrated circuit 121 controls the timing of sending the drive signal for driving the piezoelectric element 300 to the first electrode 60 based on the command signal.

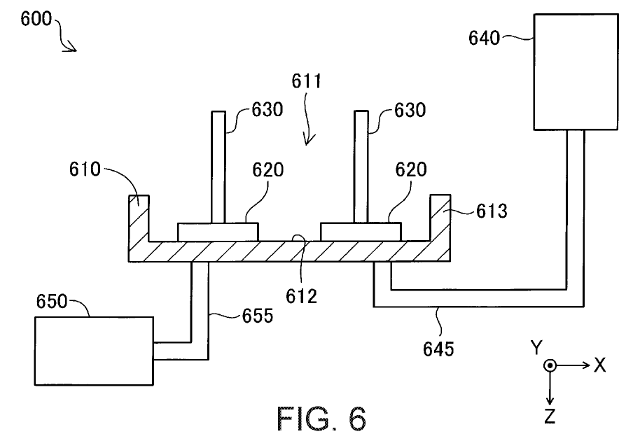

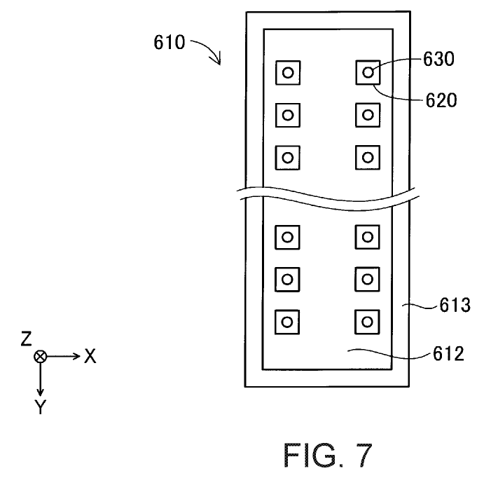

FIG. 6 is an explanatory view illustrating a schematic configuration of the washing unit 600. FIG. 7 is a top view of a cap 610 described later. The washing unit 600 includes the cap 610, an ultrasonic device 620, a vibrator 630, a washing liquid supply device 640, and a suction device 650. The cap 610 is provided so as to be attachable to the liquid ejection head 510, and is attached to the liquid ejection head 510 when the nozzles 21 are cleaned.

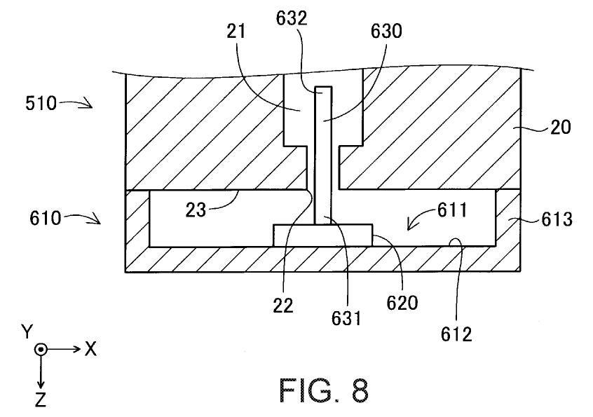

FIG. 8 is a schematic view illustrating a state in which the cap 610 is mounted on the liquid ejection head 510. In FIG. 8, only one ultrasonic device 620 and only one vibrator 630 are illustrated. The cap 610 is located below the liquid ejection head 510 in a state of being mounted on the liquid ejection head 510. The cap 610 is disposed to face the ejection surface 23 of the nozzle plate 20, and covers the ejection surface 23 in a state of being mounted on the liquid ejection head 510. Specifically, the cap 610 covers all the nozzles 21 in a state of being mounted on the liquid ejection head 510. The cap 610 is formed of, for example, a metal such as stainless steel or plastic resin.

The cap 610 has a recess section 611 in which liquid can be accumulated. The recess section 611 is configured by an inner surface 612 facing the ejection surface 23 and a side wall 613 protruding upward from the inner surface 612. The inner surface 612 is a surface of the cap 610 on the -Z direction side. In the present embodiment, the inner surface 612 is a flat surface parallel to the horizontal plane. The inner surface 612 may be a curved surface. The side wall 613 is provided on the outer peripheral section of the cap 610, and comes into contact with the ejection surface 23 in a state where the cap 610 is mounted on the liquid ejection head 510. The side wall 613 is in contact with the ejection surface 23 and, by this, the liquid supplied to the recess section 611 is prevented from leaking to the outside of the cap 610 when the nozzle 21 is washed. The side wall 613 is preferably formed from an elastic material. A packing made of the elastic material may be disposed at the upper end of the side wall 613.

As illustrated in FIGS. 6 to 8, the ultrasonic device 620 and the vibrator 630 are provided on the inner surface 612 of the cap 610. The ultrasonic device 620 and the vibrator 630 are arranged on the inner surface 612 of the cap 610 so as to be located below the nozzle opening 22 of each nozzle 21 in a state where the cap 610 is mounted on the liquid ejection head 510.

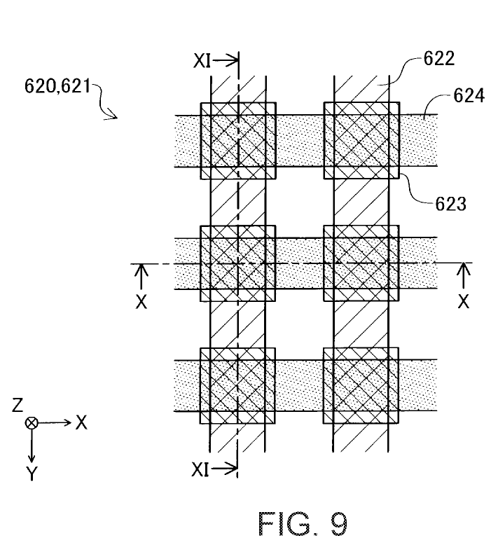

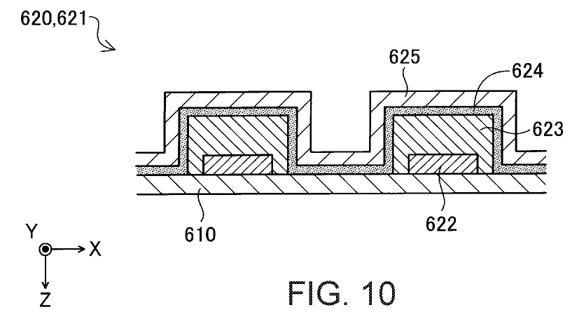

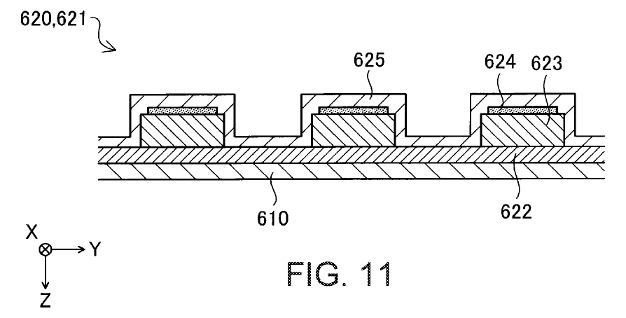

FIG. 9 is a plan view illustrating a schematic configuration of the ultrasonic device 620. FIG. 10 is a cross-sectional view taken along line X-X in FIG. 9. FIG. 11 is a cross-sectional view taken along line XI-XI in FIG. 9. In the present embodiment, the ultrasonic device 620 is a piezoelectric element 621. The ultrasonic device 620 includes a third electrode 622, a piezoelectric body 623, a fourth electrode 624, and an insulating layer 625. Note that the insulating layer 625 is omitted in FIG. 9.

The third electrode 622, the piezoelectric body 623, and the fourth electrode 624 are stacked in this order toward the -Z direction. The piezoelectric body 623 is provided between the third electrode 622 and the fourth electrode 624 in the Z direction. The third electrode 622 is a lower electrode provided on the +Z direction side of the piezoelectric body 623, that is, on the lower side of the piezoelectric body 623. The fourth electrode 624 is an upper electrode provided on the -Z direction side of the piezoelectric body 623, that is, on the upper side of the piezoelectric body 623. The third electrodes 622 extend in the Y direction and the plurality is provided along the X direction. The fourth electrodes 624 extends in the X direction and the plurality is provided along the Y direction. The piezoelectric body 623 is provided in a matrix shape in the X direction and the Y direction in a portion where the third electrode 622 and the fourth electrode 624 overlap each other in the Z direction.

The third electrode 622 and the fourth electrode 624 are formed of conductive material such as a metal such as platinum (Pt), iridium (Ir), gold (Au), or titanium (Ti), or a conductive metal oxide such as indium tin oxide abbreviated as ITO. The third electrode 622 and the fourth electrode 624 may be formed by stacking a plurality of materials such as platinum (Pt), iridium (Ir), gold (Au), titanium (Ti) and the like.

The piezoelectric body 623 may be a so-called perovskite crystal. As material of the piezoelectric body 623, for example, ferroelectric piezoelectric material such as lead zirconate titanate (PZT), material obtained by adding a metal oxide such as niobium oxide, nickel oxide, or magnesium oxide to the ferroelectric piezoelectric material, or the like can be used. Specific examples of the material include lead titanate (PbTiO₃), lead zirconate titanate (Pb(Zr,Ti)O₃), lead zirconate (PbZrO₃), lanthanum lead titanate ((Pb,La),TiO₃), lanthanum lead zirconate titanate ((Pb,La)(Zr,Ti)O₃), and magnesium niobate lead zirconate titanate (Pb(Zr,Ti)(Mg,Nb)O₃).

The material of the piezoelectric body 623 is not limited to a lead-based piezoelectric material containing lead, and a non-lead-based piezoelectric material not containing lead can also be used. Examples of the lead-free piezoelectric material include bismuth ferrate ((BiFeO₃), abbreviated as "BFO”), barium titanate ((BaTiO₃), abbreviated as "BT”), potassium sodium lithium niobate ((K,Na,Li)(NbO₃)), potassium sodium lithium tantalate niobate ((K,Na,Li)(Nb,Ta)O₃), bismuth potassium titanate ((Bi_{1/2}K_{1/2})TiO₃, abbreviated as "BKT”), bismuth sodium titanate ((Bi_{1/2}Na_{1/2})TiO₃, abbreviated as "BNT”), bismuth manganate ((BiMnO₃), abbreviated as "BM”), composite oxides containing bismuth, potassium, titanium, and iron and having a perovskite structure (x[(BiₓK₁₋ₓ)TiO₃]-(1-x)[BiFeO₃], abbreviated as "BKT-BF”), composite oxides containing bismuth, iron, barium, and titanium and having a perovskite structure ((1−x)[BiFeO₃]−x[BaTiO₃], abbreviated as "BFO-BT”), composite oxides obtained by further adding metals such as manganese, cobalt, or chromium to the aforementioned material ((1−x)[Bi(Fe_{1-y}M_{y})O₃]−x[BaTiO₃] (where M is Mn, Co, or Cr)), and the like.

A region where the third electrode 622, the piezoelectric body 623, and the fourth electrode 624 overlap in the Z direction is an active section of the piezoelectric element 621. The piezoelectric element 621 is provided such that a single active section is located below a single nozzle opening 22 when the cap 610 is mounted on the liquid ejection head 510. In FIGS. 6 to 8, a single active section of the piezoelectric element 621 is illustrated as a single ultrasonic device 620. By applying a voltage between the third electrode 622 and the fourth electrode 624, the active section of the piezoelectric element 621 vibrates in the Z direction, and an ultrasonic wave is generated in the active section. The resonance frequency of the piezoelectric element 621 is a frequency within a range from the 1 MHz to the 1000 MHz. The resonance frequency of the piezoelectric element 621 is preferably a frequency within a range from the 1 MHz to the 10 MHz. In FIGS. 9 to 11, wiring for applying a voltage to the third electrode 622 and the fourth electrode 624 is omitted.

The insulating layer 625 is formed on the upper surface of the piezoelectric element 621 including the third electrode 622, the piezoelectric body 623, and the fourth electrode 624. The insulating layer 625 is formed of, for example, aluminum oxide or zirconium oxide.

As illustrated in FIG. 8, the vibrator 630 is arranged on the upper surface of the ultrasonic device 620. Specifically, the vibrating bodies 630 are disposed one by one on the upper portions of the respective active sections of the ultrasonic device 620. The vibrator 630 is a member having columnar-shape and an axis along the Z direction. In the present embodiment, the vibrator 630 is a cylindrical member extending in the Z direction. The vibrator 630 may be a prismatic member extending in the Z direction. The vibrator 630 is formed of, for example, metal such as stainless steel or ceramic. A lower end section 631 of the vibrator 630, which is an end section on the +Z direction side, is fixed to the upper surface of the ultrasonic device 620. The lower end section 631 of the vibrator 630 is fixed to the upper surface of the insulating layer 625 by, for example, an adhesive. An upper end section 632, which is an end section of the vibrator 630 on the -Z direction side, is inserted into the nozzle 21 in a state where the cap 610 is mounted on the liquid ejection head 510. In other words, when the cap 610 covers the ejection surface 23 of the nozzle plate 20, at least a part of the vibrator 630 is disposed in the nozzle 21. The height of the vibrator 630, that is, the length of the vibrator 630 in the Z direction, is a height at which the upper end section 632 of the vibrator 630 is positioned inside the nozzle 21 in a state where the cap 610 is mounted on the liquid ejection head 510. The height of the vibrator 630 may be a height at which the upper end section 632 of the vibrator 630 is positioned in the nozzle communication path 16 in a state where the cap 610 is mounted on the liquid ejection head 510. The width of the upper end section 632 of the vibrator 630 is smaller than the diameter of the nozzle 21. Here, the width of the vibrator 630 means the length of the vibrator 630 in a direction parallel to the horizontal plane. The diameter of the nozzle 21 means the minimum value of the diameter of the nozzle 21. That is, in the present embodiment, the outer diameter of the vibrator 630 is smaller than the diameter of the nozzle 21. For example, when the diameter of the nozzle 21 is about 20 μm, the width of the upper end section 632 of the vibrator 630 is preferably about 1 μm to 15 μm. The vibrator 630 propagates the ultrasonic wave transmitted from the ultrasonic device 620, and transmits the ultrasonic wave propagated through the vibrator 630 from the upper end section 632. The vibrator 630 is preferably configured such that the resonance frequency thereof substantially coincides with the resonance frequency of the piezoelectric element 621.

The washing liquid supply device 640 illustrated in FIG. 6 supplies the washing liquid to the recess section 611 of the cap 610. As the washing liquid, for example, a solvent suitable for dissolving foreign matter adhering to the nozzle 21, the ink itself, a main solvent of the ink, or the like can be used. The washing liquid supply device 640 is coupled to the cap 610 via a connection tube 645. The connection tube 645 is, for example, a flexible hose. The washing liquid supply device 640 supplies the washing liquid from the bottom section of the cap 610 by the pressure of the water level difference. The washing liquid supply device 640 may supply the washing liquid to the recess section 611 from the opening of the cap 610, or may supply the washing liquid to the recess section 611 using a pump or the like.

The suction device 650 sucks the liquid in the recess section 611 of the cap 610. The suction device 650 is coupled to the cap 610 via a connection tube 655. The connection tube 655 is, for example, a flexible hose. The suction device 650 has a suction pump (not illustrated) and collects the washing liquid via the connection tube 655. The suction device 650 is preferably capable of applying a sufficient negative pressure to the inside of the recess section 611 of the cap 610 and the nozzle 21.

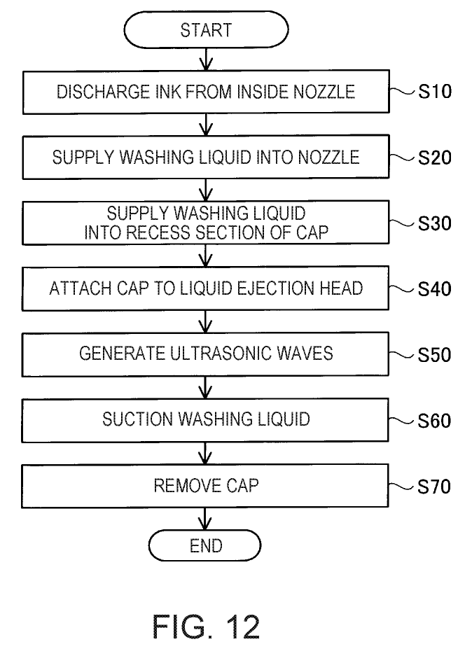

FIG. 12 is a flowchart illustrating a method of washing the nozzle 21. First, in step S10, the ink inside the nozzle 21 is discharged.

In step S20, the washing liquid is supplied into the nozzle 21. The washing liquid is supplied from the washing liquid supply device 640 to the inside of the nozzle 21 via a pipe (not illustrated). In step S20, the inside of the nozzle 21 is preferably filled with the washing liquid.

In step S30, the washing liquid is supplied from the washing liquid supply device 640 to the recess section 611 of the cap 610. The washing liquid supply device 640 supplies the washing liquid to the recess section 611 of the cap 610 so that the recess section 611 is filled with the washing liquid. At this time, the washing liquid supplied to the recess section 611 is preferably in a mound shape due to surface tension. This is to suppress generation of air bubbles between the cap 610 and the liquid ejection head 510 when the cap 610 is mounted on the liquid ejection head 510.

In step S40, the cap 610 is mounted on the liquid ejection head 510. The control section 580 controls a cap movement mechanism (not illustrated) to move the cap 610 and attach the cap 610 to the liquid ejection head 510. The cap 610 may be attached to the liquid ejection head 510 by moving the liquid ejection head 510 while fixing the position of the cap 610. The cap 610 is mounted on the liquid ejection head 510 and, by this, the vibrator 630 is inserted into the nozzle 21.

In step S50, the control section 580 applies a voltage based on the drive signal to the piezoelectric body 623 of the ultrasonic device 620. By this, the active section of the ultrasonic device 620 vibrates to generate ultrasonic waves. The control section 580 applies a voltage to the piezoelectric body 623 so that the ultrasonic device 620 transmits an ultrasonic wave having a frequency in the megahertz band. The frequency of the ultrasonic wave transmitted by the ultrasonic device 620 is preferably from 1 MHz to 10 MHz. The ultrasonic wave transmitted from the ultrasonic device 620 propagates through the vibrator 630 and is transmitted from the upper end section 632 of the vibrator 630. By this, the nozzle 21 is washed by the ultrasonic wave, and foreign matter adhering to the nozzle 21 is removed.

In step S60, the suction device 650 sucks the washing liquid in the recess section 611 of the cap 610 and in the nozzle 21.

In step S70, the control section 580 controls the cap movement mechanism to remove the cap 610 from the liquid ejection head 510. As described above, the washing of the nozzle 21 is executed.

In the cleaning of the nozzle 21, the washing liquid may be supplied to the inside of the nozzle 21 or the recess section 611 of the cap 610 after the cap 610 is mounted on the liquid ejection head 510. In this case, the cap 610 needs to be provided with a means for releasing air, such as a valve for releasing air in the cap 610 to the outside. The washing unit 600 may include a heating device for heating the washing liquid. The heating device may be provided in the cap 610 or may be provided in the washing liquid supply device 640.

According to the first embodiment described above, the washing unit 600 includes the cap 610 disposed to face and cover the ejection surface 23 of the nozzle plate 20, and the ultrasonic device 620 provided on the inner surface 612 of the cap 610 facing the ejection surface 23. The washing unit 600 further includes the vibrator 630 disposed below the nozzle opening 22. The vibrator 630 has the lower end section 631 fixed to an upper surface of the ultrasonic device 620, propagates ultrasonic waves transmitted from the ultrasonic device 620, and emits the ultrasonic waves from the upper end section 632. Therefore, the distance that the ultrasonic wave propagates in the liquid until reaching the nozzle 21 can be shortened, and attenuation of the ultrasonic wave in the process of propagation can be reduced. Therefore, it is possible to improve the performance of removing the foreign matter adhering to the nozzle 21.

In the present embodiment, the width of the upper end section 632 of the vibrator 630 is smaller than the diameter of the nozzle 21. Therefore, the vibrator 630 can transmit the ultrasonic wave toward the nozzle 21.

In the present embodiment, when the cap 610 covers the ejection surface 23, at least a part of the vibrator 630 is disposed in the nozzle 21. Therefore, it is possible to deliver ultrasonic waves having large energy to the inside of the nozzle 21, compared to a case where ultrasonic waves are transmitted from the outside of the nozzle 21 toward the nozzle 21. Therefore, it is possible to further improve the performance of removing the foreign matter adhering to the inside of the nozzle 21.

In the present embodiment, the ultrasonic device 620 transmits ultrasonic waves having a frequency in the megahertz band. The size of the foreign matter that can be removed by ultrasonic cleaning is determined by the frequency of the ultrasonic wave. In the case of ultrasonic waves having a frequency in the megahertz band, it is possible to effectively remove foreign matter having a size of about 1 μm to 10 μm. Therefore, in the present embodiment, it is possible to improve the performance of removing the foreign matter having a size of about 1 μm to 10 μm adhering to the nozzle 21.

### B. SECOND EMBODIMENT

The second embodiment is different from the first embodiment in the shape of a vibrator 630b. The configuration of each portion of the liquid ejection device 500 other than the vibrator 630b is the same as that of the first embodiment.

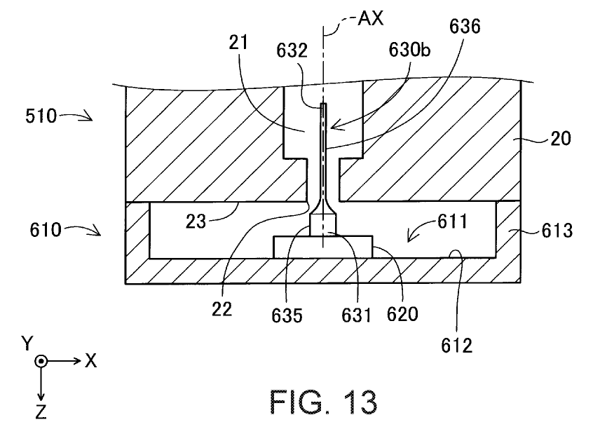

FIG. 13 is an explanatory diagram illustrating a schematic configuration of the vibrator 630b in a second embodiment. FIG. 13 illustrates a state in which the cap 610 is mounted on the liquid ejection head 510 and the vibrator 630b is inserted into the nozzle 21. In FIG. 13, only one ultrasonic device 620 and only one vibrator 630b are illustrated. In FIG. 13, similarly to FIG. 8, one active section of the piezoelectric element 621 is illustrated as the ultrasonic device 620. The vibrator 630b includes a base section 635 and a horn section 636.

The base section 635 is a cylindrical portion having an axis along the Z direction, and is located at the lower end section 631 of the vibrator 630b portion. In the present embodiment, the outer diameter of the base section 635 is smaller than the diameter of the nozzle 21. The outer diameter of the base section 635 may be equal to or larger than the diameter of the nozzle 21.

The horn section 636 is a horn-shaped section and is provided on the upper portion of the base section 635. The horn section 636 includes the upper end section 632 of the vibrator 630b. The horn section 636 is inserted into the nozzle 21 in a state where the cap 610 is mounted on the liquid ejection head 510. In other words, when the cap 610 covers the ejection surface 23 of the nozzle plate 20, at least a part of the horn section 636 is arranged in the nozzle 21. In the present disclosure, horn shape means a shape in which a cross section orthogonal to an axis thereof is a circular shape and a cross-sectional area of the cross section orthogonal to the axis continuously changes. In the present embodiment, the axis of the horn section 636 extends along the Z direction. The axis of the horn section 636 and the axis of the base section 635 coincide with each other. Hereinafter, the axis of the horn section 636 and the axis of the base section 635 are also referred to as an axis AX of the vibrator 630b. The length of the horn section 636 in the direction along the axis AX is one over an integer of the wavelength corresponding to the frequency of the ultrasonic wave transmitted from the ultrasonic device 620. The length of the horn section 636 in the direction along the axis AX is, for example, half the wavelength. The cross-sectional area of the horn section 636 in a cross section orthogonal to the axis AX decreases from the lower side toward the upper side. In the present embodiment, the horn section 636 has a cross-sectional area of a cross section orthogonal to the axis AX that abruptly changes in the vicinity of the lower end of the horn section 636. Such a shape of the horn section 636 is also referred to as a stepped horn shape.

The horn section 636 may have a shape in which the tip end section of the cone is removed. Such a shape of the horn section 636 is also referred to as a conical horn shape. The cross-sectional area of the horn section 636 in the cross section orthogonal to the axis AX may change along the axis AX according to an exponential function. Such a shape of the horn section 636 is also referred to as an exponential horn shape. The vibrator 630b may not have the base section 635.

As described above, the width of the horn section 636 decreases from the lower side toward the upper side. That is, the width of the vibrator 630b becomes smaller from the lower end section 631 toward the upper end section 632. The width of the upper end section 632 of the vibrator 630b is narrower than the width of the lower end section 631 of the vibrator 630b. Here, the width of the vibrator 630b means the length of the vibrator 630b in the direction orthogonal to the axis AX.

According to the second embodiment described above, the width of the upper end section 632 of the vibrator 630b is narrower than the width of the lower end section 631 of the vibrator 630b. Therefore, the vibrator 630b can transmit ultrasonic waves toward the nozzle 21.

In the present embodiment, the width of the vibrator 630b decreases from the lower end section 631 toward the upper end section 632. Therefore, it is possible to increase the amplitude of the ultrasonic wave transmitted from the ultrasonic device 620.

In the present embodiment, the vibrator 630b has the horn section 636 having a horn shape, and the horn section 636 includes the upper end section 632 of the vibrator 630b. As described above, in the horn section 636, the cross-sectional area of the cross section orthogonal to the axis AX continuously decreases from the lower side toward the upper side. By this, the vibration energy of the ultrasonic wave transmitted from the ultrasonic device 620 can be concentrated, and the amplitude of the ultrasonic wave can be increased. The ultrasonic waves with increased amplitudes can be transmitted from the upper end section 632 of the vibrator 630b. In particular, when the horn section 636 has a stepped horn shape, the amplitude of the ultrasonic wave can be greatly increased. In a case where the horn section 636 has a conical horn shape, the amplitude of the ultrasonic wave can be increased. In a case where the horn section 636 has an exponential horn shape, since energy loss is small, the vibration energy of the ultrasonic wave can be efficiently transmitted.

In the present embodiment, the length of the horn section 636 in the direction along the axis AX is one over an integer of the wavelength corresponding to the frequency of the ultrasonic wave transmitted from the ultrasonic device 620. Therefore, the horn section 636 resonates with the ultrasonic wave transmitted from the ultrasonic device 620. By this, it possible to increase the amplitude of the ultrasonic wave.

### C. THIRD EMBODIMENT

The third embodiment is different from the first embodiment in the shape of a vibrator 630c. The configuration of each section of the liquid ejection device 500 other than the vibrator 630c is the same as that of the first embodiment.

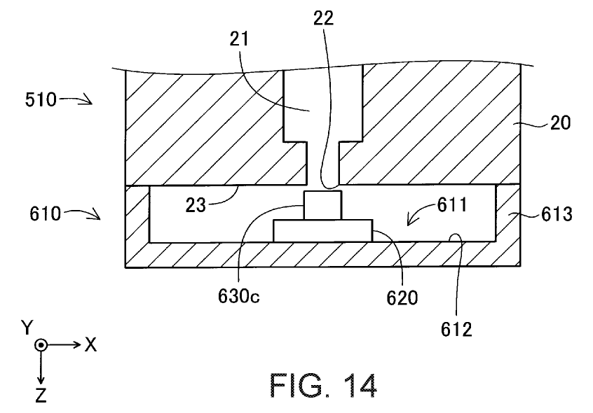

FIG. 14 is an explanatory diagram illustrating a schematic configuration of the vibrator 630c in a third embodiment. FIG. 14 illustrates a state in which the cap 610 is mounted on the liquid ejection head 510. In FIG. 14, only one ultrasonic device 620 and only one vibrator 630c are illustrated. In FIG. 14, similarly to FIG. 8, one active section of the piezoelectric element 621 is illustrated as the ultrasonic device 620.

In the third embodiment, the vibrator 630c is a cylindrical member having an axis along the Z direction. The vibrator 630c may be a prismatic member having an axis along the Z direction, a rectangular parallelepiped, or the like. In the third embodiment, the sum of the height of the ultrasonic device 620 and the height of the vibrator 630c is lower than the height of the side wall 613. Here, height means the length of each member in the vertical direction. That is, even when the cap 610 is mounted on the liquid ejection head 510, the vibrator 630c is not inserted into the nozzle 21. The width of the upper end section 632 of the vibrator 630c is wider than the diameter of the nozzle 21.

According to the third embodiment described above, the cap 610 has the side wall 613 that protrudes upward from the inner surface 612 and is in contact with the ejection surface 23, and the sum of the height of the ultrasonic device 620 and the height of the vibrator 630c is lower than the height of the side wall 613. Therefore, the distance that the ultrasonic wave propagates in the liquid until reaching the nozzle 21 can be shortened, and attenuation of the ultrasonic wave in the process of propagation can be reduced. Therefore, it is possible to improve the performance of removing the foreign matter adhering to the nozzle 21.

### D. OTHER EMBODIMENTS

(D-1) In the above embodiment, the ultrasonic device 620 is a piezoelectric element. In contrast, the ultrasonic device 620 may be any device capable of generating ultrasonic waves, and is not limited to a piezoelectric element. The ultrasonic device 620 may be individually provided below the nozzle opening 22 of each nozzle 21.

(D-2) In the above embodiment, the ultrasonic device 620 transmits an ultrasonic wave having a frequency in the megahertz band. In contrast, the ultrasonic device 620 may transmit ultrasonic waves of a frequency other than the megahertz band.

(D-3) In the third embodiment, the width of the upper end section 632 of the vibrator 630c is wider than the diameter of the nozzle 21. In contrast, in the third embodiment, the width of the upper end section 632 of the vibrator 630c may be narrower than the diameter of the nozzle 21.

(D-4) In the first embodiment and the third embodiment, the width of the vibrator 630 is constant regardless of the position in the vertical direction. In contrast, in the first embodiment or the third embodiment, the width of the vibrator 630 may decrease discontinuously from the lower end section 631 toward the upper end section 632.

(D-5) In step S50 of the method of washing the nozzle 21 illustrated in FIG. 12, the control section 580 may vibrate only a part of the active section of the ultrasonic device 620 and generate ultrasonic waves only from a part of the ultrasonic device 620 by applying a voltage based on the drive signal only to a part of the piezoelectric body 623 of the ultrasonic device 620. For example, the control section 580 may vibrate only the active section disposed below the nozzle 21 to which the foreign matter is attached, and may not vibrate the active section disposed below the nozzle 21 to which the foreign matter is not attached.

### E. OTHER FORMS

The present disclosure is not limited to the above-described embodiments and can be realized in various forms without departing from the spirit thereof. For example, the present disclosure can also be realized by the following aspects. The technical features in the above-described embodiments corresponding to the technical features in each aspect described below can be appropriately replaced or combined in order to solve a part or all of the problems of the present disclosure or in order to achieve a part or all of the effects of the present disclosure. If the technical features are not described as essential in this specification, the technical features can be appropriately omitted.

(1) According to a first aspect of the present disclosure, a washing device is provided. The washing device includes a liquid ejection head and a washing unit disposed below the liquid ejection head, wherein the liquid ejection head includes a piezoelectric element, a diaphragm that vibrates by drive of the piezoelectric element, a pressure chamber that applies pressure to liquid stored therein by vibration of the diaphragm, and a nozzle plate in which are formed a plurality of nozzles that communicate with the pressure chamber and that eject the liquid, the nozzle plate has, on a lower surface of the nozzle plate, an ejection surface in which is formed a nozzle opening of a nozzle, and the washing unit includes a cap that is disposed to face the ejection surface and that covers the ejection surface, an ultrasonic device disposed on an inner surface of the cap that faces the ejection surface, and a vibrator that is disposed below the nozzle opening, that has a lower end fixed to an upper surface of the ultrasonic device, that propagates ultrasonic waves transmitted from the ultrasonic device, and that transmits the ultrasonic waves from an upper end thereof.

According to such an aspect, the distance over which the ultrasonic wave propagates through the liquid until reaching the nozzle can be shortened, and attenuation of the ultrasonic wave in the process of propagation can be reduced. Therefore, it is possible to improve the performance of removing the foreign matter adhering to the nozzle.

(2) The above aspect may be such that a width of the upper end of the vibrator is smaller than a diameter of the nozzle.

According to such an aspect, the vibrator can transmit the ultrasonic wave toward the nozzle.

(3) The above aspect may be such that when the cap covers the ejection surface, at least a part of the vibrator is located within the nozzle.

According to such an aspect, it is possible to deliver ultrasonic waves having large energy to the inside of the nozzle compared to a case where ultrasonic waves are transmitted from the outside of the nozzle toward the nozzle. Therefore, it is possible to further improve the performance of removing the foreign matter adhering to the inside of the nozzle.

(4) The above aspect may be such that a width of an upper end of the vibrator is smaller than a width of the lower end of the vibrator.

According to such an aspect, the vibrator can transmit the ultrasonic wave toward the nozzle.

(5) The above aspect may be such that the width of the vibrator decreases from the lower end of the vibrator toward the upper end of the vibrator.

According to such an aspect, the amplitude of the ultrasonic wave transmitted from the ultrasonic device can be increased.

(6) The above aspect may be such that the vibrator includes a horn section having a horn shape and the horn section includes the upper end of the vibrator.

According to such an aspect, it is possible to concentrate the vibration energy of the ultrasonic wave transmitted from the ultrasonic device and increase the amplitude of the ultrasonic wave. The ultrasonic wave with increased amplitude can be transmitted from the upper end of the vibrator.

(7) The above aspect may be such that the cap has a side wall that protrudes upward from the inner surface and that contacts the ejection surface and a sum of a height of the ultrasonic device and a height of the vibrator is lower than a height of the side wall.

According to such an aspect, the distance over which the ultrasonic wave propagates through the liquid until reaching the nozzle can be shortened, and attenuation of the ultrasonic wave in the process of propagation can be reduced. Therefore, it is possible to improve the performance of removing the foreign matter adhering to the nozzle.

(8) The above aspect may be such that the ultrasonic device transmits ultrasonic waves having a frequency in a megahertz band.

In the case of the ultrasonic wave having the frequency in the megahertz band, it is possible to effectively remove the foreign matter having the size of about 1 μ m to 10 μ m, and thus, according to such an aspect, it is possible to improve the performance of removing the foreign matter having the size of about 1 μ m to 10 μ m attached to the nozzle.

What is claimed is:

1. A washing device comprising:
a liquid ejection head and
a washing unit disposed below the liquid ejection head, wherein
the liquid ejection head includes
a piezoelectric element,
a diaphragm that vibrates by drive of the piezoelectric element,
a pressure chamber that applies pressure to liquid stored therein by vibration of the diaphragm, and
a nozzle plate in which at least one nozzle is formed that communicates with the pressure chamber,
the nozzle plate has an ejection surface in which a nozzle opening is formed, and
the washing unit includes
a cap that is disposed to face the ejection surface and that covers the ejection surface,
an ultrasonic device disposed on an inner surface of the cap that faces the ejection surface, and
a vibrator that is disposed below the nozzle opening, that has a lower end fixed to an upper surface of the ultrasonic device, that propagates ultrasonic waves transmitted from the ultrasonic device, and that transmits the ultrasonic waves from an upper end thereof.

2. The washing device according to claim 1, wherein
a width of the upper end of the vibrator is smaller than a diameter of the nozzle.

3. The washing device according to claim 2, wherein
when the cap covers the ejection surface, at least a part of the vibrator is located within the nozzle.

4. The washing device according to claim 2, wherein
a width of an upper end of the vibrator is smaller than a width of the lower end of the vibrator.

5. The washing device according to claim 4, wherein
the width of the vibrator decreases from the lower end of the vibrator toward the upper end of the vibrator.

6. The washing device according to claim 4, wherein
the upper end of the vibrator has a horn shape.

7. The washing device according to claim 1, wherein
the cap has a side wall that protrudes upward from the inner surface and that contacts the ejection surface and
a sum of a height of the ultrasonic device and a height of the vibrator is lower than a height of the side wall.

8. The washing device according to claim 1, wherein
the ultrasonic device transmits ultrasonic waves having a frequency in a megahertz band.
